(19) United States
(12) Patent Application Publication
(10) Pub. No.: US 2009/0009059 A1
(43) Pub. Date: Jan. 8, 2009

(54) Metallic compound hybridized nanophosphor layer, applications thereof, and method of preparing a metallic compound hybridized nanophosphor layer

(76) Inventors: Soon-Jae Kwon, Yongin-si (KR); Hyun-Sik Kim, Yongin-si (KR)

Correspondence Address: ROBERT E. BUSHNELL, 1522 K STREET NW, SUITE 300, WASHINGTON, DC, 20005-1202, US

(21) Appl. No.: 12/213,193

(22) Filed: Jun. 16, 2008

(30) Foreign Application Priority Data
Jul. 6, 2007 (KR) 10-2007-0068181

(51) Int. Cl. H01J 1/62; B05D 5/12

(52) U.S. Cl. 313/503; 427/64

(57) ABSTRACT

A metallic compound hybridized nanophosphor layer, in which the metallic compound is metallic oxide or metallic sulfide. The metallic compound hybridized nanophosphor layer is prepared in consideration of physical, mechanical, and chemical stabilities. The metallic compound hybridized nanophosphor layer has an excellent light scattering effect and high durability against damage from ion-bombardment. In addition, the charging effect caused by V-UV vacuum-ultraviolet ray can be considerably reduced. Thus, the metallic compound hybridized nanophosphor layer is very suitable for various display devices having high efficiency and high resolution. Accordingly, a display device using the metallic compound hybridized nanophosphor layer shows high performance and long lifetime. The method of forming the metallic compound hybridized nanophosphor layer is a low temperature layer forming process through which a thin film-type layer can be formed at low temperature. Therefore, a phosphor layer having physical, mechanical, and chemical stabilities can be formed at low cost.

### CROSS-REFERENCE TO RELATED PATENT APPLICATIONS AND CLAIM OF PRIORITY

This application claims the benefit of Korean Patent Application No. 10-2007-0068181, filed on Jul. 6, 2007, in the Korean Intellectual Property Office, the disclosure of which is incorporated herein in its entirety by reference.

### BACKGROUND OF THE INVENTION

1. Field of the Invention

The present invention relates to a nanophosphor film hybridized with metallic compounds in which the metallic compound is metallic oxide or metallic sulfide, applications thereof, and a method of preparing a metallic compound hybridized nanophosphor layer.

2. Description of the Related Art

Phosphor is a substance that exhibits the phenomenon of fluorescence/phosphorescence (short/sustained glowing after exposure to oxygen or energized particles such as electrons, or lights such as ultraviolet/vacuum-ultraviolet/visible light). In general, a phosphor is used in light sources such as Hg (mercury) phosphor lamps or Hg-free phosphor lamps, or various kinds of devices such as a field emission device or a plasma display panel. Phosphor is expected to be used in a wider range of applications as the multimedia industry develops.

Nanophosphor refers to a phosphor having a nano size. Use of nanophosphor can lower a light scattering effect compared with the use of a conventional bulky phosphor.

According to a conventional method of preparing a phosphor layer using inorganic phosphor particles, a phosphor paste composition including phosphor particles, an organic surfactant, a binder, and a solvent is applied and then the applied composition is thermally treated, so that a phosphor layer is formed while the solvent is removed. Such a conventional method can be used in a bulky phosphor. However, when the conventional method is used with nanophosphor which has a small particle size and a large specific surface area, surface defects may occur due to high temperature heat treatment, and chemical degradation may occur at the surface of nanophosphor particles. These problems may lead to a decrease in phosphor characteristics and further, loss of phosphor characteristics. Accordingly, there is a need to develop a method of preparing a phosphor layer.

When a nanophosphor layer prepared using the conventional method is used in display devices, optical properties and physical and chemical stabilities such as stability with respect to ion-bombardment and thermal stability, cannot be obtained. Thus, such a nanophosphor is unsuitable for operation methods of a display. Specifically, plasma display panels (PDPs) require durability against ion bombardment and a function to be able to remove a charging effect, but such a nanophosphor does not comply with the requirements described above.

### SUMMARY OF THE INVENTION

The present invention provides an improved phosphor layer.

The present invention provides an improved method of preparing the phosphor layer.

The present invention provides a metallic compound hybridized nanophosphor layer having excellent properties prepared in consideration of physical, mechanical, chemical stabilities.

The present invention also provides various uses for display devices using the metallic compound hybridized nanophosphor layer.

The present invention also provides a method of fabricating the metallic compound hybridized nanophosphor layer at low temperature.

The present invention also provides a metallic compound hybridized nanophosphor layer prepared according to the method described above.

According to an aspect of the present invention, there is provided a phosphor layer, including nanophosphor hybridized with a metallic compound, wherein the metallic compound is metallic oxide or metallic sulfide.

The metallic compound can be MgO, Y₂O₃, ZnO, ZrO₂, La₂O₃, Gd₂O₃, ZnS, or Gd₂S₃.

According to another aspect of the present invention, there is provided plasma display panel including the nanophosphor layer, wherein the nanophosphor layer is located at a rear part of a plasma discharge space.

According to another aspect of the present invention, there is provided a light emission device (LED) including a light source and a phosphor coating formed on the light source, the phosphor coating comprised of the nanophosphor layer.

According to another aspect of the present invention, there is provided, an inorganic electroluminescence device including: a substrate; an anode; a first inorganic dielectric layer; an emission layer; a second inorganic dielectric layer; and a cathode, wherein the emission layer is the nanophosphor layer.

According to another aspect of the present invention, there is provided, a field emission display device (FED) includes the nanophosphor layer.

According to another aspect of the present invention, there is provided a phosphor layer, including phosphor particles having sizes smaller than the wavelength of visible light and a metallic compound positioned between the phosphor particles, the metallic compound chemically bound to the phosphor particles, the metallic compound being metallic oxide or metallic sulfide.

According to another aspect of the present invention, there is provided method of forming a metallic compound hybridized nanophosphor layer, the method including: (a) forming a nanophosphor layer on a substrate; (b) immersing the substrate on which the nanophosphor layer is formed in a metal precursor solution to permeate metal ions into the nanophosphor layer; and (c) contacting the result of (b) with an aqueous or alcohol solution of base, Li₂S, Na₂S, K₂S, or (NH₄)₂S to form metallic hydroxide, metallic oxide, or metallic sulfide in the nanophosphor layer

The method can further include heat-treating the result of (c).

According to another aspect of the present invention, there is provided a metallic compound hybridized nanophosphor layer formed using the method.

The metallic compound hybridized nanophosphor layer according to the present invention is prepared in consideration of physical, mechanical, chemical stabilities to obtain excellent phosphor layer properties. Thus, the metallic compound hybridized nanophosphor layer is suitable for various display devices. In addition, the method of forming a metallic compound hybridized nanophosphor layer according to the present invention can provide a metallic compound hybridized nanophosphor layer having physical, mechanical, and chemical stabilities in mild conditions.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partially exploded perspective view of a plasma display panel according to an embodiment of the present invention;

FIG. 2 is a sectional view of a pixel of a plasma display panel according to another embodiment of the present invention;

FIGS. 3A to 3C are sectional views of a light emission device according to other embodiments of the present invention;

FIG. 4 is a schematic view of an inorganic electroluminescence device according to another embodiment of the present invention;

FIG. 5 is a schematic, perspective view of a field emission device according to the present invention;

FIG. 6 is a sectional view taken along line II-II of FIG. 5;

FIG. 7 is a view illustrating a method of fabricating a MgO hybridized nanophosphor layer according to an embodiment of the present invention;

FIG. 8 is a view illustrating a method of fabricating a MgO hybridized nanophosphor layer according to another embodiment of the present invention;

FIG. 9 are images of top views of a metallic compound hybridized nanophosphor layer prepared according to another embodiment of the present invention and a phosphor layer which does not include a metallic compound;

FIG. 10 are images of sectional views of a metallic compound hybridized nanophosphor layer prepared according to another embodiment of the present invention and a phosphor layer which does not include a metallic compound; and

FIG. 11 shows the emission spectra of metallic compound hybridized nanophosphor layers prepared according to another embodiment of the present invention and a conventional phosphor layer.

### DETAILED DESCRIPTION OF THE INVENTION

The present invention will now be described more fully with reference to the accompanying drawings, in which exemplary embodiments of the invention are shown.

According to an aspect of the present invention, the present invention provides a nanophosphor layer formed by hybridizing a nanophosphor with a metallic compound. The metallic compound can be metallic oxide or metallic sulfide. Specifically, a metal contained in the metallic compound can be Mg, Y, Zn, Zr, La, or Gd. Examples of such a metallic compound can include MgO, Y₂O₃, ZnO, ZrO₂, La₂O₃, Gd₂O₃, ZnS, Gd₂S₃, and the like. These materials are wide-band gap materials having high light transmission in a visible light range.

Use of the nanophosphor layer prepared using nanophosphor according to the present invention can result in a substantial decrease in a light scattering effect. In addition, in the nanophosphor layer, a metallic compound such as metallic oxide or metallic sulfide is interposed between nanophosphor particles, so that the nanophosphor layer can secure mechanical, physical, and chemical stability. That is, the metallic compound such as metallic oxide or metallic sulfide, interposed between nanophosphor particles is chemically bound to nanophosphor particles, so that a bonding force between nanophosphor particles which form the nanophosphor layer is increased.

Specifically, since MgO is optically transparent, use of a hybridized MgO:nanophosphor layer may result in a substantial decrease in a light scattering effect, or may prevent a light scattering effect. In addition, since the nanophosphor layer is formed as a thin-film, an ultraviolet (UV) into visible light conversion and visible-transmissive phosphor layer can be formed. In addition to MgO, other wide band-gap materials such as Y₂O₃, ZnO, ZrO₂, La₂O₃, Gd₂O₃, ZnS, or Gd₂S₃ can provide the same effects. Such a nanophosphor layer is suitable for LED related applications such as a backlight unit (BLU) for a display, and new types of display devices using a thin-film type phosphor layer such as a fine pitch PDP or a transmissive and luminescent PDP.

When the metallic compound is a metallic oxide, the nanophosphor can be a metallic oxide-based phosphor such as YBO₃:Eu, Y(P,V)O₄:Eu, (Y,Gd)BO₃:Eu, Zn₂SiO₄:Mn, YBO₃:Tb, Y₂O₃:Eu, BaMgAl₁₀O₁₇:Eu(BAM), CaMgSi₂O₆:Eu(CMS), (Ba,Eu)Mg₂Al₁₆O₂₇, BaMgAl₁₀O₁₇:Eu,Mn, (La,Ce,Tb)PO₄:Ce,Tb, MgGa₂O₄:Mn, Y₃Al₅O₁₂:Ce(YAG:Ce), YAG:Eu, YAG:Tb, YAG:Nd, or a combination thereof.

When the metallic compound is a metallic sulfide, the nanophosphor can be a metallic sulfide-based phosphor such as CdS:In, (Zn,Cd)S:Cu,Al, ZnS:Ag, ZnS:Ag,Al, or a combination thereof.

In the metallic compound hybridized nanophosphor layer according to an embodiment of the present invention, the metallic compound such as metallic oxide or metallic sulfide may bind nanophosphor particles together, and physically and chemically protect surfaces of the nanophosphor particles. In particular, due to its high durability against damage from ion-bombardment, the metallic compound hybridized nanophosphor layer according to an embodiment of the present invention is suitable as a phosphor layer of a plasma display panel. Furthermore, ion bombardments and vacuum-ultraviolet ray (V-UV)-induced charging effect can be substantially prevented, and a visible light scattering effect can be substantially reduced due to nano-sized phosphor particles. Thus, the metallic compound hybridized nanophosphor layer according to an embodiment of the present invention is suitable for LEDs. Such characteristics may be obtained due to the fact that the metallic compound increases the binding force between nanoparticles and functions as a dielectric. Accordingly, the metallic compound hybridized nanophosphor layer according to an embodiment of the present invention is very suitable for various display devices.

According to another aspect of the present invention, the present invention provides a plasma display panel including the metallic compound hybridized nanophosphor layer according to an embodiment of the present invention. In this case, the metallic compound hybridized nanophosphor layer can be disposed on a front part of a plasma discharge space, and alternatively, the metallic compound hybridized nanophosphor layer can also be disposed on a rear part of the plasma discharge space.

The plasma display panel according to an embodiment of the present invention includes a phosphor layer formed of phosphor particles which have sizes that are smaller than the wavelength of visible light, that is, nanophosphor particles. Such a nanophosphor layer can be prepared using a low temperature-solution process without a physical or chemical change in nanophosphor particles. For example, such a nanophosphor layer can be formed using a method of preparing a nanophosphor layer according to an embodiment of the present invention, which will be described later. Specifically, when the nanophosphor layer is formed using a method of forming a nanophosphor layer according to an embodiment of the present invention, which will be described later, no physical degradation occurs and thus, the scattering of visible light can be prevented/minimized. Thus, a plasma display panel including such a nanophosphor layer can show high performance and efficiency.

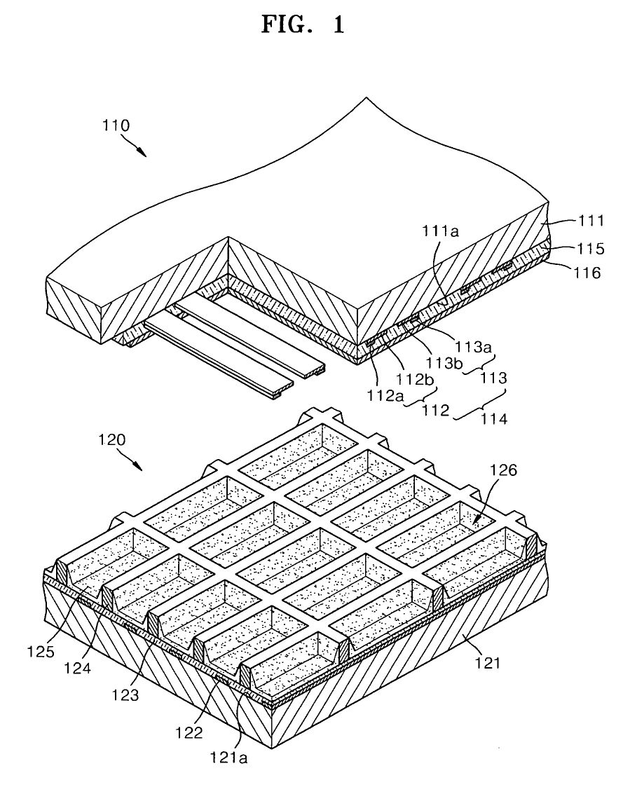

FIG. 1 is a partially exploded perspective view of a plasma display panel including the metallic compound hybridized nanophosphor layer according to an embodiment of the present invention.

Referring to FIG. 1, the plasma display panel according to an embodiment of the present invention includes a front panel 110 and a rear panel 120. The front panel 110 includes a front substrate 111, pairs of sustain electrodes 114 formed on a bottom surface 11a of the front substrate 111 in which each sustain electrode includes a Y electrode 112 and an X electrode 113, a front dielectric layer 115 covering the pairs of sustain electrodes, and a protective layer 116 covering the front dielectric layer 115. The Y electrode 112 and the X electrode 113 respectively include: transparent electrodes 112b and 113b formed of ITO or the like, and bus electrodes 112a and 113a each including a black electrode (not shown) capable of improving contrast properties, and a white electrode (not shown) capable of providing conductivity. The bus electrodes 112a and 113a are connected to connecting cables disposed at left and right sides of a plasma display panel.

The rear panel 120 includes a rear substrate 121, address electrodes 122 extending in a direction perpendicular to the pairs of sustain electrodes 114 on a front surface 121a of the rear substrate 121, a rear dielectric layer 123 covering the address electrodes 122, and barrier ribs 124 partitioning emission cells 126 formed on the rear dielectric layer 123. The address electrodes 122 are connected to connecting cables disposed at up and down sides of the plasma display panel.

A nanophosphor layer 125 according to an embodiment of the present invention is disposed in the emission cells 126 formed between the front panel 110 and the rear panel 120.

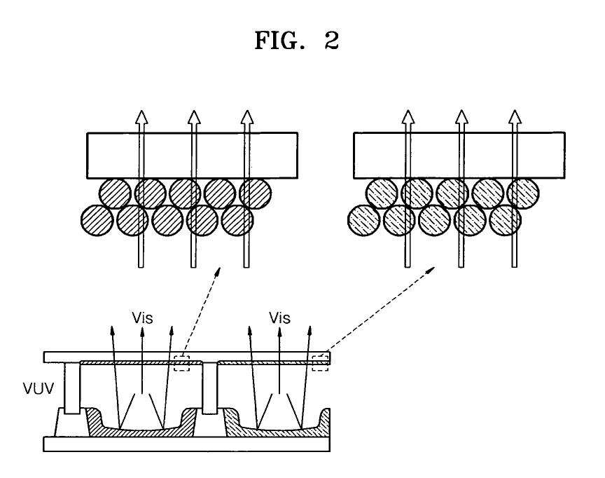

FIG. 2 is a view of a nanophosphor layer formed inside the emission cells 126, that is, at front and rear parts of a plasma discharge space.

Since the nanophosphor layer is formed using nanophosphor particles having sizes that are smaller than a wavelength of the visible light range, a scattering effect with respect to visible light can be prevented. Thus, when the nanophosphor layer is formed at the front part of the emission cells (i.e., when the nanophosphor layer is formed on the bottom surface of the front panel), a visible light generated by excitement caused by vacuum-ultraviolet (V-UV) light can be emitted and transmitted in the front direction so that a highly efficient transmissive plasma display panel can be designed and fabricated. The nanophosphor layer disposed at the front part can act as a light conversion phosphor layer which converts UV light into visible light, and also acts as a visible transmissive phosphor layer which transmits visible light itself. In addition, visible light entering the plasma display panel is not scattered or reflected by the phosphor layer but passes through. As a result, a clear image can be obtained.

In addition, a nanophosphor layer formed at the rear part of the emission cells (i.e., at the front surface of the rear panel) can prevent the visible light scattering, and thus substantially acts as a thin-film type phosphor.

According to another aspect of the present invention, the present invention provides a light emission device (LED) including the metallic compound hybridized nanophosphor layer according to the embodiment of the present invention.

The metallic compound hybridized nanophosphor layer according to an embodiment of the present invention can be used in a LED including a light emitting diode acting as a light source. Such a LED can be used in back lights of traffic lights, communicating devices, and various display devices. Furthermore, such a LED can also be used in next-generation materials which replace conventional illuminating material.

A LED which emits red (R) light, green (G) light, blue (B) light, and white light can be operated in such a color conversion way that R, G, and B phosphors are dispersed in a polymer resin at a front side of a UV or blue emission diode, and then, the R, G, and B phosphors are excited by the UV or blue emission diode acting as a light source, thereby generating visible light.

In a conventional method, a bulky phosphor having a particle size of unit μm is dispersed in and combined with a polymer resin in an emission unit of a UV/Blue LED diode. When this method is used, however, light scattering occurs due to the bulky phosphor and thus light extraction efficiency can be decreased. In addition, use of a high power UV/Blue diode which is required to obtain a high power LED can lead to chemical instabilities such as degradation or decoloration of the polymer resin in which the phosphor is dispersed. The problems described above can be overcome in the LED according to an embodiment of the present invention using the metallic compound hybridized nanophosphor layer according to an embodiment of the present invention.

In addition, without use of a polymer resin, a nanophosphor layer in which nanophosphor particles are stabilized with MgO can be deposited as an individual R, G, or B layers, a mixture layer of R:G:B, or a R/G/B deposited structure on a diode to provide R, G, B, or white emission. At this time, at least one layer selected from the R, G, B phosphor layers can be the nanophosphor layer according to an embodiment of the present invention. When such a nanophosphor layer is used, scattering of visible light due to phosphor particles can be prevented and thus high light extraction efficiency can be obtained. In addition, since the polymer resin is not used, durability of a high power LED can be secured.

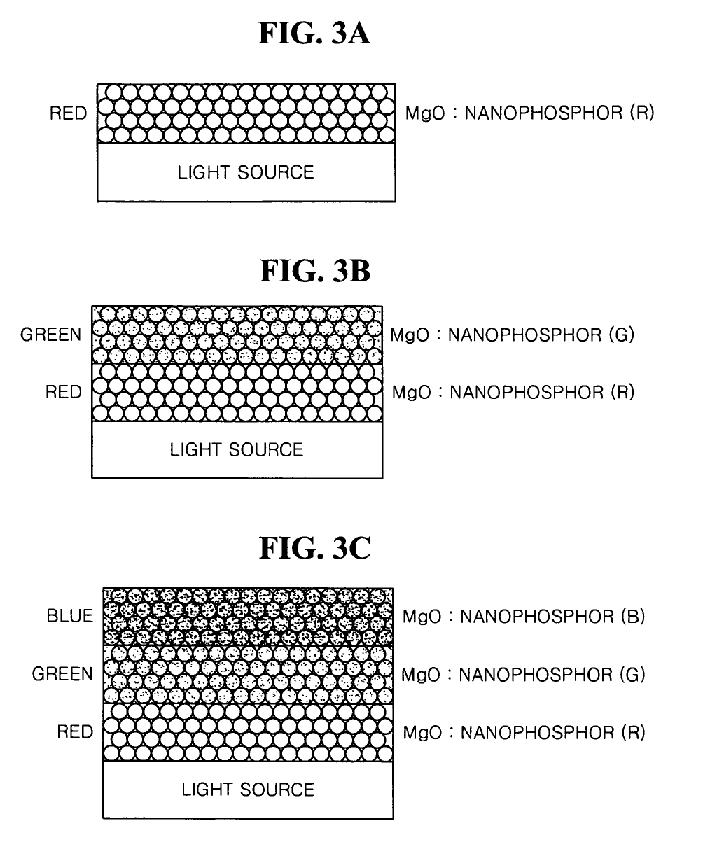

FIGS. 3A to 3C are sectional views of a LED according to embodiments of the present invention.

In the LED according to an embodiment of the present invention, a nanophosphor of the nanophosphor layer is not limited, and can be a red phosphor, a green phosphor, a blue phosphor, or a mixture of at least two phosphors selected from the red phosphor, the green phosphor, and the blue phosphor.

According to another aspect of the present invention, the present invention provides an inorganic electroluminescence device including: a substrate, an anode, a first inorganic dielectric layer, an emission layer, a second inorganic dielectric layer, and a cathode, in which the emission layer is the nanophosphor layer according to an embodiment of the present invention.

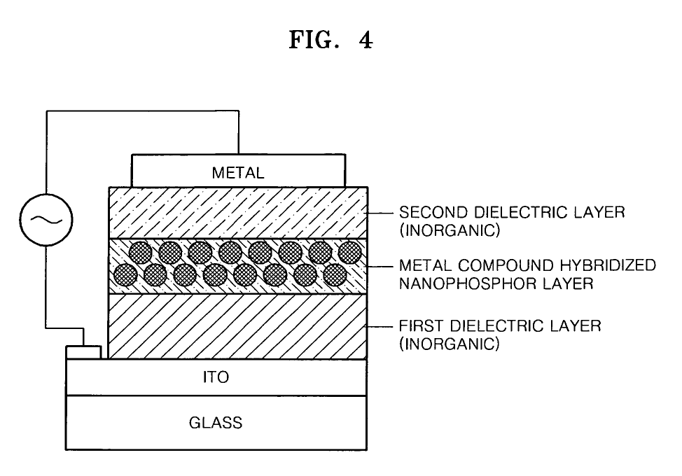

FIG. 4 is a schematic view of an inorganic electroluminescence device according to another embodiment of the present invention. Referring to FIG. 4, an ITO electrode, a first inorganic dielectric layer, an emission layer, a second inorganic dielectric layer, and a metal electrode are sequentially deposited on a glass substrate. The inorganic electroluminescence device can be operated by applying a current to the ITO electrode and the metal electrode.

The inorganic electroluminescence device according to an embodiment of the present invention includes a phosphor layer which is prepared by forming a nanophosphor layer stabilized with a metallic compound such as metallic oxide, for example, MgO, or metallic sulfide. Thus, a thin-film type phosphor layer can be prepared using a solution process, for example, a method of preparing a nanophosphor layer according to an embodiment of the present invention, which will be described later. The nanophosphor layer according to an embodiment of the present invention, specifically, a thin-film type phosphor layer is suitable for use as an emission layer of an inorganic electroluminescence device.

According to another aspect of the present invention, the present invention provides a field emission display device (FED) including the nanophosphor layer according to an embodiment of the present invention.

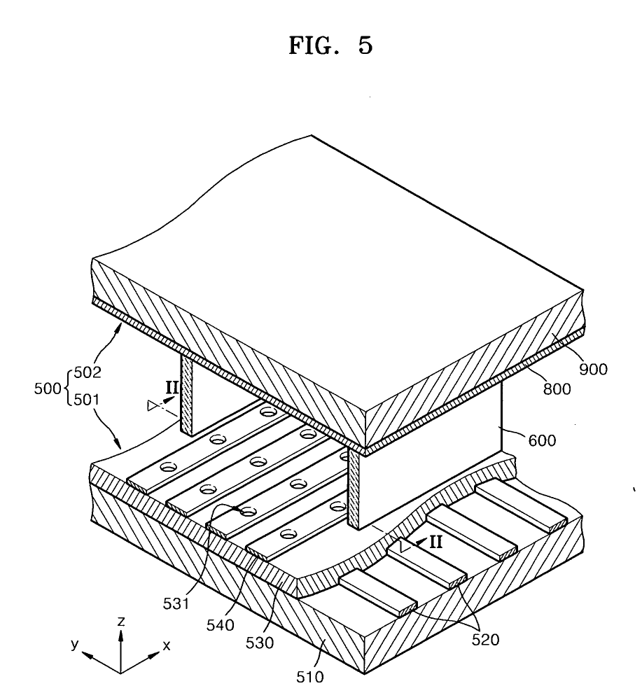

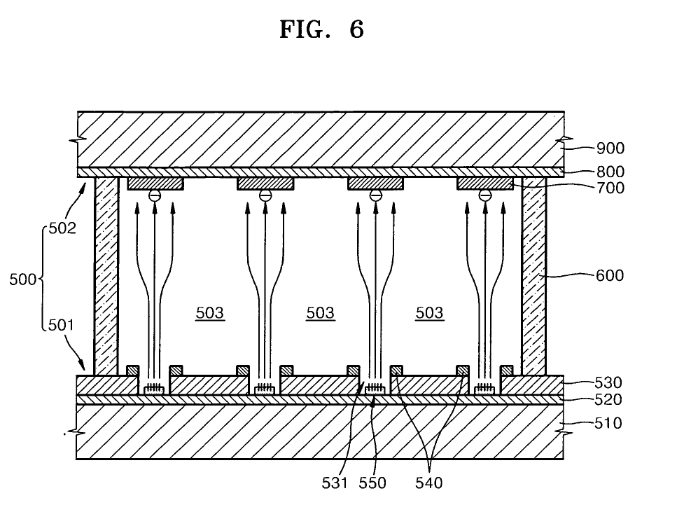

FIG. 5 is a schematic, partial perspective view of a top gate-type field emission device according to an embodiment of the present invention, and FIG. 6 is a sectional view taken along line II-II of FIG. 5.

Referring to FIGS. 5 and 6, a field emission display device 500 includes a field emission device 501, a front panel 502 disposed parallel to the field emission device 501, an emission space 503 which is a vacuum and is formed between the field emission device 501 and the front panel 502, and a spacer 600 maintaining a distance between the field emission device 501 and the front panel 502.

The field emission device 501 includes a first substrate 510, cathode electrodes 520 disposed on the first substrate 510, gate electrodes 540 disposed extending in a direction perpendicular to the cathode electrodes 540, and an insulating layer 530 which is disposed between the gate electrodes 540 and the cathode electrodes 520 and electrically insulates the gate electrodes 540 from the cathode electrodes 520.

Electron emission source holes 531 are formed in areas in which the gate electrodes 540 meet the cathode electrodes 520, and an electron emission source 550 is disposed in each of the electron emission source holes 531.

The front panel 502 includes a second substrate 900, an anode electrode 800 disposed on a bottom surface of the second substrate 900, and a phosphor layer 700 disposed on a bottom surface of the anode electrode 800.

The phosphor layer is prepared by forming a nanophosphor layer where nanophosphor particles are hybridized with metallic compounds according to an embodiment of the present invention.

The field emission display device according to an embodiment of the present invention has been described with reference to FIGS. 5 and 6. The field emission display device according to the present invention is not limited thereto. For example, the field emission display device can further include a second insulating layer, and/or a focusing electrode.

According to another aspect of the present invention, the present invention provides a method of preparing a nanophosphor layer where nanophosphor particles are hybridized with metallic compounds. According to an embodiment of the present invention, the method includes (a) forming a nanophosphor layer on a substrate, (b) immersing the substrate on which the nanophosphor layer is formed in a metal precursor solution, and (c) contacting the result of (b) with an aqueous or alcohol solution of base, Li₂S, Na₂S, K₂S or (NH₄)₂S to form metallic hydroxide, metallic oxide, or metallic sulfide.

In (a), the nanophosphor layer can be formed on the substrate using any method of forming a phosphor layer which is known in the pertinent art. For example, a composition including nanophosphor particles and a solvent can be printed, dried, and then sintered. The composition can further include, in addition to nanophosphor particles and the solvent, one or more additives which are known in the pertinent art. An example of such an additive is a surfactant.

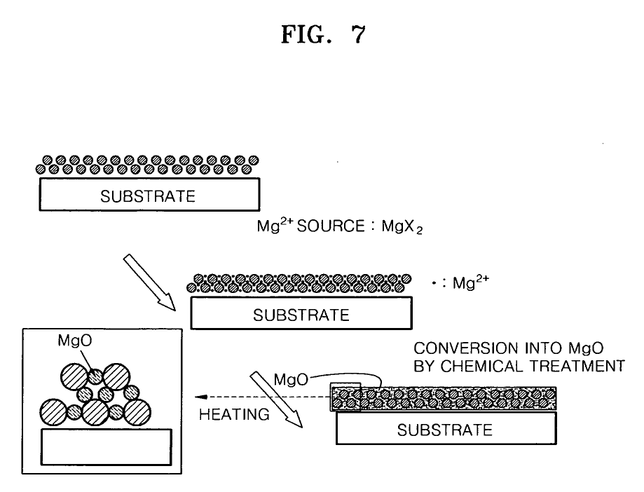

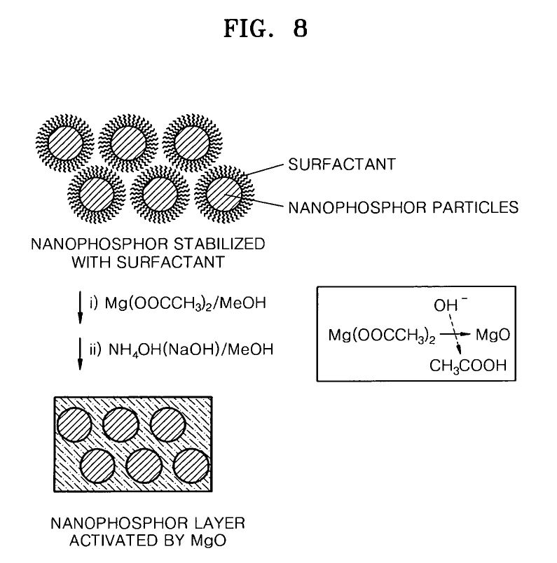

Through (b), metallic ions of the metal precursor solution permeate between nanophosphor particles formed on the substrate (refer to FIGS. 7 and 8).

In the metal precursor solution, a metal precursor can be any material that can be used as a supplying source of Mg, Y, Zn, Zr, La, Gd, Zn, or Gd. Specifically, the metal precursor can be Mg(COOCH₃)₂, magnesium acetylacetonate [Mg(C₅H₇O₂)₂], ZnCl₂, Zn(NO₃)₂, Zn(COOCH₃)₂, Zn(C₅H₇O₂)₂, LaCl₃, La(NO₃)₃, La(COOCH₃)₃, La(C₅H₇O₂)₃, GdCl₃, Gd(NO₃)₃, Gd(COOCH₃)₃, or Gd(C₅H₇O₂)₃. In the metal precursor solution, a solvent can be water, alcohol, acetonitrile, or the like.

In (b), the concentration of the metal precursor solution may be in the range from 0.01 to 0.1 N. When the concentration of the metal precursor solution used in (b) is less than 0.01 N, nano particles may be insufficiently bound to each other. On the other hand, when the concentration of the metal precursor solution used in (b) is more than 0.1 N, MgO can be formed in large particles at the surface of the formed layer or between nanophosphor particles, and thus, adverse effects can occur on the morphology of the nanophosphor layer.

In (b), for example, the substrate on which the nanophosphor layer is formed obtained through (a) can be immersed in the metal precursor solution for at least 5-30 minutes.

Through (c), the metallic ions interposed between nanophosphor particles chemically react with an aqueous base solution or an alcohol solution to form metallic hydroxide which is solid or metallic oxide which is solid. As a result, the nanophosphor layer can become more rigid due to chemical binding between the metallic compound and nanophosphor particles.

In (c), to form a MgO hybridized nanophosphor layer, the aqueous solution of base used can be NH₄OH, NaOH, KOH, an alcohol solution, or the like, and to form a metal sulfide (e.g., ZnS) hybridized nanophosphor layer, a solution of Na₂S, Li₂S, K₂S, (NH₄)₂S, an alcohol solution, or the like can be used. Specifically, when NaOH solution that is a base solution is used, a base residue such as Na+, can remain. Therefore, use of a material that leaves no residue such as NH₄OH, is desired. The residual of the base solution can be removed using, for example, a heat treating process in a vacuum condition or an atmospheric condition.

Through (c), metallic hydroxide or metallic oxide can be formed between nanophosphor particles. The metallic hydroxide obtained can be transformed into metallic oxide by performing a heat treatment process on the result of (c). Accordingly, the method of preparing a metallic compound hybridized nanophosphor layer according to an embodiment of the present invention can further include heat treating the result of (c). The additional heat treatment can be performed at the temperature at which the metal hydroxide is converted into the metal oxide. For example, the heat treatment can be performed at 100 to 500° C. for 20 minutes to 2 hours depending on the kinds of the metal hydroxide. More particularly, the transition temperature to convert zinc hydroxide (Zn(OH)₂) to zinc oxide (ZnO) is about 125° C. in the atmospheric condition. The transition temperature to convert zirconium hydroxide (Zr(OH)₄) to zirconium oxide (ZrO₂) is about 410° C. in a vacuum condition and 500° C. in the atmospheric condition.

The method of preparing a metallic compound hybridized nanophosphor layer according to an embodiment of the present invention is a novel low temperature layer forming process. The method can provide chemical and physical stabilities to a layer to be formed using the method. Thus, a nanophosphor layer formed at low temperature using the method according to an embodiment of the present invention can have excellent chemical and physical properties.

In addition, a metallic compound hybridized nanophosphor layer prepared using the method according to an embodiment of the present invention, as described above, has high mechanical and chemical strengths resulting from large binding forces between nanophosphor particles due to the presence of metallic oxide or metallic sulfide, high durability with respect to ion bombardment damages, a low charging effect, and a low visible light scattering effect. Thus, the metallic compound hybridized nanophosphor layer is suitable for various display devices.

In addition, the method of forming a metallic compound hybridized nanophosphor layer according to an embodiment of the present invention is suitable to form a thin-film type nanophosphor layer.

When a conventional method of preparing a bulky phosphor layer in which a paste composition is added and then is heat-treated to form a layer is applied to nanophosphor particles, phosphor particles in the phosphor layer formed may have defects at their surface and the surfaces may be chemically degraded, and thus, phosphor properties of the phosphor layer may be degraded or lost. These problems, however, can be overcome by using the method of preparing a metallic compound hybridized nanophosphor layer according to the embodiment of the present invention. Thus, the method of preparing a metallic compound hybridized nanophosphor layer according to the embodiment of the present invention can contribute to an improvement in properties of a display using phosphor.

FIG. 7 is a schematic view illustrating a method of forming a MgO:nanophosphor hybrid layer in which a nanophosphor layer is hybridized with MgO by sequential chemical bath deposition according to an embodiment of the present invention. A hybrid structure of MgO and nanophosphor particles obtained by performing a heat treatment process at the temperature at which Mg(OH)₂ is converted into MgO (280° C. in a vacuum condition, 350° C. in the atmospheric condition) or higher is illustrated in the box located at the lower left corner of FIG. 7.

FIG. 8 is a schematic view illustrating a method of forming a nanophosphor layer stabilized with a metallic compound by sequential chemical bath deposition using a low temperature-solution process in the case of nanophosphor particles dispersed using surfactants or the like. Through the method described in FIG. 8, organic surfactants disposed at surfaces of nanophosphor particles which have been dispersed by organic surfactants can be removed and coated with MgO. In addition, the MgO can make nanophosphor particles bound to each other to stabilize the nanophosphor layer. Furthermore, organic materials such as surfactants can be removed, and nanophosphor particles can be densely arranged, and thus a phosphor layer to be formed can be finer and thinner than a phosphor layer prepared by heat-treating a bulky phosphor. The surfactants can be removed on the basis that a binding between metal at the surface of phosphor and a surfactant is changed into a metal-OH binding by a base solution, and then the resultant product is converted into metallic oxide through a heat treatment.

The present invention also provides a metallic compound hybridized nanophosphor layer prepared using the method of forming a metallic compound hybridized nanophosphor layer according to an embodiment of the present invention.

The present invention will be described in further detail with reference to the following examples. These examples are for illustrative purposes only and are not intended to limit the scope of the present invention.

### EXAMPLE 1

YBO₃:Eu nanophosphor was used as a phosphor. A nanophosphor layer was formed by performing a wetting process at room temperature and atmospheric pressure.

Then, a glass substrate on which the nanophosphor layer was formed was immersed in a methanol solution in which the concentration of Mg²⁺-containing salt dissolved was 0.05 N for 15 minutes, thereby allowing Mg²⁺ to permeate between the nanophosphor particles. Alternatively, Mg²⁺-containing solution can be mixed with the nanophosphor particles and may be casted on the substrate surface. Then, the resultant product was treated with an NH₄OH aqueous solution so that the permeated Mg²⁺ was converted to MgO/Mg(OH)₂ between the nanophosphor particles. Mg(OH)₂ was converted into MgO by performing a heat treatment at 300° C. in a vacuum condition which is higher than a transition temperature. As a result, a MgO:YBO₃:Eu nanophosphor hybrid layer was formed.

### EXAMPLE 2

The same method as described in Example 1 was used using Zn²⁺-containing salt instead of Mg²⁺-containing salt, so that ZnO/Zn(OH)₂ was formed between nanophosphor particles. Then, Zn(OH)₂ was converted into ZnO by performing a heat treatment process at 125° C. which is at or higher than a transition temperature. As a result, a ZnO:YBO₃:Eu nanophosphor hybrid layer was formed.

### EXAMPLE 3

The same method as described in Example 1 was used using La³⁺-containing salt instead of Mg²⁺-containing salt, so that La₂O₃/La(OH)₃ was formed between nanophosphor particles. Then, La(OH)₃ was converted into La₂O₃ by performing a heat treatment process at 340° C. which is at or higher than a transition temperature. As a result, a La₂O₃:YBO₃:Eu nanophosphor hybrid layer was formed.

### EXAMPLE 4

The same method as described in Example 1 was used using Gd³⁺-containing salt instead of Mg²⁺-containing salt, so that Gd₂O₃/Gd(OH)₃was formed between nanophosphor particles. Then, Gd(OH)₃ was converted into Gd₂O₃ by performing a heat treatment process at 340° C. which is at or higher than a transition temperature. As a result, a Gd₂O₃:YBO₃:Eu nanophosphor hybrid layer was formed.

### COMPARATIVE EXAMPLE 1

A YBO₃:Eu nanophosphor was casted on a glass substrate to form a phosphor layer, and then the phosphor layer was heat-treated using the same temperature condition as in Example 1.

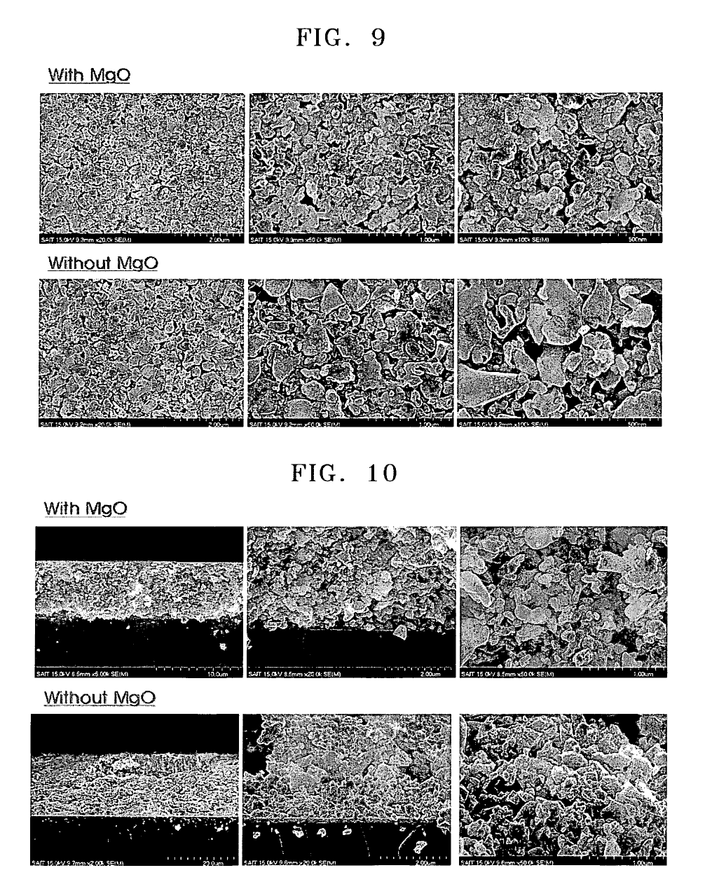

FIG. 9 shows scanning electron microscopic images of plane surfaces of the nanophosphor layers prepared according to Example 1 and Comparative Example 1 (upper images—Example 1, lower images—Comparative Example 1). In FIG. 9, magnification increases from left to right. Referring to FIG. 9, in the nanophosphor layer prepared according to Example 1, small-sized MgO was formed at the surface of the nanophosphor layer. However, the surface of the nanophosphor layer prepared according to Comparative Example 1 in which the nanophosphor layer was not treated with MgO was different from the surface of the nanophosphor layer prepared according to Example 1 in which the nanophosphor layer was treated with MgO.

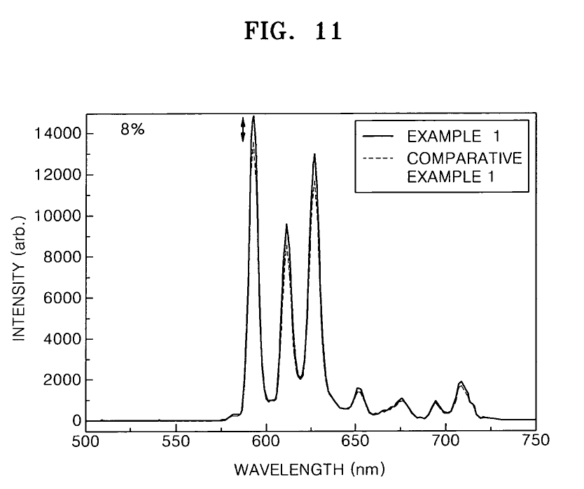

FIG. 10 shows scanning electron microscopic images of sections of the nanophosphor layers prepared according to Example 1 and Comparative Example 1 (upper images—Example 1, lower images—Comparative Example 1). In FIG. 10, magnification increases from left to right. When the nanophosphor layer was treated with MgO according to Example 1, the cutting surfaces of the nanophosphor layer is clearly shown, on the other hand, when the nanophosphor layer was not treated with MgO according to Comparative Example 1, the nanophosphor layer collapsed due to weak bindings between phosphor particles in the nanophosphor layer.

FIG. 11 illustrates emission spectra of the nanophosphor layers prepared according to Example 1 in which the nanophosphor layer was treated with MgO and Comparative Example 1 in which the nanophosphor layer was not treated with MgO, in which the nanophosphor layers were excited with vacuum UV of 254 nm.

A metallic compound hybridized nanophosphor layer according to the embodiments of the present invention was prepared in consideration of physical, mechanical, chemical stabilities. The metallic compound hybridized nanophosphor layer can substantially decrease a light scattering effect, and has high durability with respect to ion-bombardment damages, and a considerably low charging effect caused by a vacuum-ultraviolet (V-UV) ray. Due to such effects, the metallic compound hybridized nanophosphor layer is suitable for various display devices having high efficiency and high resolution. Accordingly, a display device including the metallic compound hybridized nanophosphor layer shows high performance and long lifetime.

A method of forming a metallic compound hybridized nanophosphor layer according to the present invention is a low-temperature layer forming process. The method is suitable for forming a thin film-type layer at low temperature. Thus, a phosphor layer can be formed at low cost using the method to be physically, mechanically, and chemically stable.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A phosphor layer, comprising nanophosphor hybridized with a metallic compound, the metallic compound being metallic oxide or metallic sulfide.

2. The nanophosphor layer of claim 1, wherein the metallic compound is MgO, Y₂O₃, ZnO, ZrO₂, La₂O₃, Gd₂O₃, ZnS, or Gd₂S₃.

3. The nanophosphor layer of claim 1, wherein the metallic compound is metallic oxide, and the nanophosphor in the phosphor layer comprises at least one selected from the group consisting of YBO₃:Eu; Y(P,V)O₄:Eu; (Y,Gd)BO₃:Eu; Zn₂SiO₄:Mn, YBO₃:Tb, Y₂O₃:Eu, BaMgAl₁₀O₁₇:Eu(BAM), CaMgSi₂O₆:Eu(CMS), (Ba,Eu)Mg₂Al₁₆O₂₇, BaMgAl₁₀O₁₇:Eu,Mn, (La,Ce,Tb)PO₄:Ce,Tb, MgGa₂O₄:Mn, Y₃Al₅O₁₂:Ce(YAG:Ce), YAG:Eu, YAG:Tb, YAG:Nd, and a combination thereof.

4. The nanophosphor layer of claim 1, wherein the metallic compound is metallic sulfide, and the nanophosphor in the phosphor layer comprises at least one selected from the group consisting of CdS:In, (Zn,Cd)S:Cu,Al, ZnS:Ag, ZnS:Ag,Al, and a combination thereof.

5. A plasma display panel comprising a front panel, a rear panel, emission cells formed between the front panel and the rear panel, and the phosphor layer of claim 1 formed on a front part of the emission cells.

6. A plasma display panel comprising a front panel, a rear panel, emission cells formed between the front panel and the rear panel, and the phosphor layer of claim 1 formed on a rear part of the emission cells.

7. A light emission device (LED) comprising a light source and a phosphor coating formed on the light source, the phosphor coating comprising the phosphor layer of claim 1.

8. The light emission device of claim 7, wherein the phosphor coating is at least one selected from the group consisting of a red phosphor layer, a green phosphor layer, a blue phosphor layer, a layer having a mixture of two or more of a red phosphor, a green phosphor, a blue phosphor, and a structure having the red phosphor layer, the green phosphor layer and the blue phosphor layer which are sequentially deposited on the light source.

9. An inorganic electroluminescence device comprising a substrate, an anode formed on the substrate, a first inorganic dielectric layer formed on the anode, an emission layer formed on the first inorganic dielectric layer, a second inorganic dielectric layer formed on the emission layer, and a cathode formed on the second inorganic dielectric layer, wherein the emission layer is the phosphor layer of claim 1-.

10. A field emission display device (FED) comprising the phosphor layer of claim 1.

11. A phosphor layer, comprising:
phosphor particles having sizes smaller than the wavelength of visible light; and
a metallic compound positioned between the phosphor particles, the metallic compound chemically bound to the phosphor particles, the metallic compound being metallic oxide or metallic sulfide.

12. The phosphor layer of claim 11, wherein the metallic compound is selected from the group consisting of MgO, Y₂O₃, ZnO, ZrO₂, La₂O₃ and Gd₂O₃; and
the phosphor particles are at least one selected from the group consisting of YBO₃:Eu; Y(P,V)O₄:Eu; (Y,Gd)BO₃:Eu; Zn₂SiO₄:Mn, YBO₃:Tb, Y₂O₃:Eu, BaMgAl₁₀O₁₇:Eu(BAM), CaMgSi₂O₆:Eu(CMS), (Ba,EU)Mg₂A₁₆O₂₇, BaMgAl₁₀O₁₇:Eu,Mn, (La,Ce,Tb)PO₄:Ce,Tb, MgGa₂O₄:Mn, Y₃Al₅O₁₂:Ce(YAG:Ce), YAG:Eu, YAG:Tb, YAG:Nd, and a combination thereof.

13. The nanophosphor layer of claim 11, wherein the metallic compound is ZnS or Gd₂S₃; and
the phosphor particles are in the phosphor layer comprises at least one selected from the group consisting of CdS:In, (Zn,Cd)S:Cu,Al, ZnS:Ag, ZnS:Ag,Al, and a combination thereof.

14. A method of forming a phosphor layer, the method comprising:
(a) forming a nanophosphor layer on a substrate;
(b) immersing the substrate on which the nanophosphor layer is formed in a metal precursor solution containing a metal ion to permeate the metal ion into the nanophosphor layer; and
(c) contacting the result of (b) with an aqueous or alcohol solution of one selected from the group consisting of base, Li₂S, Na₂S, K₂S, and (NH₄)₂S to form metallic hydroxide, metallic oxide or metallic sulfide in the nanophosphor layer.

15. The method of claim 14, further comprising heat-treating the result of (c) to covert the metallic hydroxide into the metallic oxide at the temperature range of at 100 to 500° C.

16. The method of claim 14, wherein the metal precursor solution comprises a metal precursor selected from the group consisting of Mg(COOCH₃)₂, [Mg(C₅H₇O₂)₂], ZnCl₂, Zn(NO₃)₂, Zn(COOCH₃)₂, Zn(C₅H₇O₂)₂, LaCl₃, La(NO₃)₃, LA(COOCH₃)₃, La(C₅H₇O₂)₃, GdCl₃, Gd(NO₃)₃, Gd(COOCH₃)₃, and Gd(C₅H₇O₂)₃.

17. The method of claim 14, wherein the concentration of the metal precursor solution is in the range from 0.01 to 0.1 N.

18. The method of claim 14, wherein in (b), the substrate on which the nanophosphor layer is formed is immersed in the metal precursor solution for 5 to 30 minutes.

19. The phosphor layer of claim 14, wherein the metallic compound is selected from the group consisting of MgO, Y₂O₃, ZnO, ZrO₂, La₂O₃, Gd₂O₃ ZnS and Gd₂S₃.

20. A phosphor layer formed by the method of claim 14.
